(19) United States
(12) Patent Application Publication
(10) Pub. No.: US 2026/0260316 A1
(43) Pub. Date: Sep. 3, 2026

(54) IMAGE PROCESSING METHOD USING NEURAL NETWORK MODEL, AND ELECTRONIC DEVICE FOR PERFORMING SAME

(71) Applicant: SAMSUNG ELECTRONICS CO., LTD., Suwon-si (KR)

(72) Inventors: Gyehyun KIM, Suwon-si (KR); Beomseok KIM, Suwon-si (KR); Yongsup PARK, Suwon-si (KR); Youjin LEE, Suwon-si (KR); Sangmi LEE, Suwon-si (KR); Taeyoung JANG, Suwon-si (KR); Kwangpyo CHOI, Suwon-si (KR); Minseok CHOI, Suwon-si (KR)

(73) Assignee: SAMSUNG ELECTRONICS CO., LTD., Suwon-si (KR)

(21) Appl. No.: 19/655,014

(22) Filed: Apr. 22, 2026

Related U.S. Application Data
(63) Continuation of application No. PCT/KR2024/013624, filed on Sep. 9, 2024.

(30) Foreign Application Priority Data
Nov. 6, 2023 (KR) 10-2023-0151933

(51) Int. Cl. G06T 3/4053; G06T 3/4046; G06T 7/90

(52) U.S. Cl. CPC G06T 3/4053; G06T 3/4046; G06T 7/90

(57) ABSTRACT

An image processing method using a neural network model, and an electronic device are provided. The method may comprise: acquiring a low-resolution image; extracting, from the low-resolution image, luminance information through a luminance channel; acquiring a first feature vector on the basis of the luminance information by using the neural network model to which a first weight is applied; acquiring an output image from the first feature vector by using the neural network model to which a second weight is applied; and generating, on the basis of the output image, a high-resolution image with respect to the low-resolution image. The first weight and the second weight can be different.

### CROSS-REFERENCE TO RELATED APPLICATIONS

This application is a continuation of International Application No. PCT/KR2024/013624, filed on September 9, 2024, which claims priority to Korean Patent Application No. 10-2023-0151933 filed on November 6, 2023 in the Ministry of Intellectual Property of the Republic of Korea, the disclosures of which are incorporated herein in their entireties by reference.

### TECHNICAL FIELD

The present disclosure relates to a method and an electronic device for processing an image by using a neural network model. More specifically, the present disclosure relates to a method and an electronic device for increasing the resolution of an image by using a neural network model.

### BACKGROUND ART

With developments in technology, artificial intelligence (AI) is being used in various fields and has become an important technology driving future innovation. AI is a computer system that learns, thinks, and acts in a similar way to human intelligence, and may process vast amounts of data compared to humans. Representative technologies of AI include data analysis or prediction, pattern recognition, machine learning, neural networking, natural language processing, and the like.

A neural network is modeled by mathematical expressions by imitating a form in which human neurons are connected, and uses an algorithm that imitates the ability of humans to learn through neurons. Using the algorithm, the neural network may perform data learning by generating mapping between input data and output data. The neural network may generate the output data with respect to the input data that has not been used, based on a learned result.

The neural network is also used in an image processing method, and learning through deep learning may be performed by using a low-resolution image and a high-resolution image. A trained neural network model may generate a high-resolution image from a new low-resolution image that is not used for training.

Image super-resolution technology is used for image processing to improve the resolution and quality of a given image when processing a low-resolution or pixelated image. Single-image super-resolution technology operates based on a deep learning model for the purpose of improving the resolution of a single input image. Multi-image super-resolution technology utilizes a plurality of low-resolution images for the same object, aligns and fuses the images, and generates a high-resolution composite image. In the image super-resolution technology, a method of performing resolution enhancement by repeatedly using the neural network model is also proposed. When the neural network model is recursively used, there are limitations in that unnecessary memory is used due to images being generated as intermediate output values and a same weight is applied whenever the neural network model is repeatedly used.

### SOLUTION TO PROBLEM

According to an embodiment of the present disclosure, a method for image processing using a neural network model is provided. The method may obtain a low-resolution image. The method may extract luminance information from the low-resolution image through a luminance channel. The method may obtain a first feature vector based on the luminance information, by using a first neural network model to which a first weight is applied. The method may obtain an output image corresponding to the first feature vector, by using a second neural network model to which a second weight is applied. The method may generate a high-resolution image for the low-resolution image based on the output image. The first neural network model and the second neural network model may have the same connection structure.

According to an embodiment of the present disclosure, an electronic device for image processing using a neural network model may include memory storing one or more instructions and at least one processor configured to execute the one or more instructions stored in the memory. The at least one processor may obtain a low-resolution image. The at least one processor may extract luminance information from the low-resolution image through a luminance channel. The at least one processor may obtain a first feature vector based on the luminance information, by using a first neural network model to which a first weight is applied. The at least one processor may obtain an output image corresponding to the first feature vector, by using a second neural network model to which a second weight is applied. The at least one processor may generate a high-resolution image for the low-resolution image based on the output image. The first neural network model and the second neural network model may have the same connection structure.

According to an embodiment of the present disclosure, there may be provided a computer-readable recording medium having recorded thereon a program for executing the method on a computer.

### BRIEF DESCRIPTION OF DRAWINGS

FIG. 1 is a diagram illustrating an operation of processing an image by using a neural network model as a plurality of modules, according to an embodiment of the present disclosure.

FIG. 2 is a diagram illustrating a specific operation of processing an image by using a neural network model, according to an embodiment of the present disclosure.

FIG. 3 is a flowchart illustrating an operation of processing an image by using a neural network model, according to an embodiment of the present disclosure.

FIG. 4 is a diagram illustrating an operation of processing an image by using a value stored in a memory for a neural network model, according to an embodiment of the present disclosure.

FIG. 5 is a diagram for describing a layer for adjusting the number of channels, according to an embodiment of the present disclosure.

FIG. 6 is a flowchart for describing image registration performed for image processing, according to an embodiment of the present disclosure.

FIG. 7 is a diagram illustrating image registration performed for image processing, according to an embodiment of the present disclosure.

FIG. 8 is a diagram for describing bilinear upsampling performed for image processing, according to an embodiment of the present disclosure.

FIG. 9 is a schematic block diagram of an electronic device according to an embodiment of the present disclosure.

### DETAILED DESCRIPTION

Hereinafter, embodiments of the present disclosure will be described in detail with reference to the accompanying drawings.

As the disclosure allows for various changes and numerous examples, particular embodiments of the disclosure will be illustrated in the drawings and described in detail in the written description. However, this is not intended to limit the embodiments of the present disclosure, and it should be understood that the present disclosure includes all modifications, equivalents, and substitutes included in the spirit and technical scope of various embodiments.

In describing the embodiments, when it is determined that a detailed description of a related known technology may unnecessarily obscure the gist of the present disclosure, the detailed description thereof will be omitted. In addition, numbers (e.g., first, second, etc.) used in the description of the specification are merely identification codes for distinguishing one component from another component.

The terms used in the embodiments of the present specification have been selected as currently widely used general terms as possible while considering the functions of the present disclosure, but may vary depending on the intention of a person skilled in the art, precedents, the emergence of new technologies, and the like. In addition, in certain cases, there are terms arbitrarily selected by the applicant, and in this case, the meaning will be described in detail in the description of the corresponding embodiment. Therefore, the terms used in the present disclosure should be defined based on the meaning of the terms and the whole context of the present disclosure, rather than simple names of the terms.

The scope of the present disclosure may be indicated by the claims to be described below rather than the detailed description. Various features mentioned in one claim category of the present disclosure (e.g., in a method claim) may be claimed in another claim category (e.g., in a system claim) as well. In addition, an embodiment of the present disclosure may include various combinations of individual features within the appended claims as well as combinations of features specified in the appended claims. It should be construed that all changes or modifications derived from the meaning and scope of the claims and the equivalent concept thereof are included in the scope of the present disclosure.

Also, in the present disclosure, regarding a component represented as a ‘… unit’ or a ‘module’, two or more components may be combined into one element or one component may be divided into two or more components according to subdivided functions. These functions may be implemented in hardware or software, or may be implemented in a combination of hardware and software. In addition, each component described hereinafter may additionally perform some or all of functions performed by another component, in addition to main functions of itself, and some of the main functions of each component may be performed entirely by another component.

The singular forms “a,” “an,” and “the” are intended to include the plural forms as well, unless the context clearly indicates otherwise. The terms used herein, including technical or scientific terms, may have the same meanings as those generally understood by one of ordinary skill in the art described in the present disclosure.

Throughout the present disclosure, unless otherwise stated, “or” is inclusive and not exclusive. Thus, unless expressly indicated otherwise or indicated otherwise in the context, “A or B” may represent “A, B, or both.” In the present disclosure, the phrase “at least one of” or “one or more”, when used with a list of items, may mean that different combinations of one or more of the listed items may be used or that only one item in the list may be needed. For example, “at least one of A, B, and C” may include any of the following combinations: A, B, C, A and B, A and C, B and C, or A and B and C.

It will be understood that each block of flowchart illustrations and combinations of blocks in the flowchart illustrations may be implemented by computer program instructions. Because these computer program instructions may be loaded into a processor of a general-purpose computer, special purpose computer, or other programmable data processing equipment, the instructions, which are executed via the processor of the computer or other programmable data processing equipment generate means for performing the functions specified in the flowchart block(s). Because these computer program instructions may also be stored in a computer-executable or computer-readable memory that may direct the computer or other programmable data processing equipment to function in a particular manner, the instructions stored in the computer- executable or computer-readable memory may produce an article of manufacture including instruction means for performing the functions stored in the flowchart block(s). Because the computer program instructions may also be loaded into a computer or other programmable data processing equipment, a series of operational steps may be performed on the computer or other programmable data processing equipment to produce a computer implemented process, and thus, the instructions executed on the computer or other programmable data processing equipment may provide steps for implementing the functions specified in the flowchart block(s).

In addition, each block may represent a module, a segment, or a portion of code including one or more executable instructions for executing a specified logical function(s). It should also be noted that in some alternative execution examples, the functions mentioned in the blocks may occur out of order. For example, two blocks shown in succession may in fact be executed substantially concurrently or the blocks may sometimes be executed in the reverse order, depending upon the functionality involved.

Throughout the specification, when a part “includes” a certain component, this means that other components may be further included, rather than excluding other components, unless otherwise stated. Also, the term “… unit” or “… module” refers to a unit that performs at least one function or operation, and the unit may be implemented in hardware or software or in a combination of hardware and software.

Hereinafter, embodiments of the present disclosure will be described in detail with reference to the accompanying drawings so that one of ordinary skill in the art may easily implement the present disclosure. However, the present disclosure may be implemented in various different forms and is not limited to the embodiments described herein. In addition, in order to clearly describe the present disclosure in the drawings, parts irrelevant to the description are omitted, and similar reference numerals denote similar parts throughout the specification.

Functions related to artificial intelligence (AI) according to the present disclosure are operated through a processor and a memory. The processor may include one or more processors. In this case, the one or more processors may include a general-purpose processor such as a central processing unit (CPU), an application processor (AP), or a digital signal processor (DSP), a dedicated graphics processor such as a graphics processing unit (GPU) or a vision processing unit (VPU), or an AI processor such as a neural processing unit (NPU). The one or more processors control to process input data according to a predefined operation rule or an AI model stored in the memory. Alternatively, when the one or more processors are AI processors, the AI processors may be designed in a hardware structure specialized in dealing with a specific AI model.

A predefined operation rule or AI model is created through training. When a predefined operation rule or AI model is created through training, it means that the predefined operation rule or the AI model is established by training a basic AI model using a plurality of training data according to a learning algorithm to perform a desired feature (or objective). Such training may be performed by a device itself in which AI is performed according to the present disclosure or by a separate server and/or system. Examples of the learning algorithm include, but are not limited to, supervised learning, unsupervised learning, semi-supervised learning, and reinforcement learning.

The AI model may include a plurality of neural network layers. The plurality of neural network layers have a plurality of weight values, and a neural network operation is performed through an operation between an operation result of a previous layer and the plurality of weight values. The plurality of weight values of the neural network layers may be optimized by a result of training the AI model. For example, the plurality of weight values may be updated to reduce or minimize a loss value or a cost value obtained by the Al model during a training procedure. An artificial neural network may include a deep neural network (DNN), and may include, but is not limited to, a convolutional neural network (CNN), a DNN, a recurrent neural network (RNN), a restricted Boltzmann machine (RBM), a deep belief network (DBN), a bidirectional recurrent deep neural network (BRDNN), or a deep Q-network.

The terms used herein will be briefly described, and an embodiment of the present disclosure will be described in detail.

The terms used herein are those defined in consideration of functions in the present disclosure, but the terms may vary according to the intention of users or operators, precedents, etc. Hence, the terms used herein should be defined based on the meaning of the terms together with the descriptions throughout the specification.

In the present disclosure, “resolution” may refer to a degree of detail of an image expressed on paper or a screen.

In the present disclosure, a “luminance channel” is one of channels constituting a color space, and may refer to a channel representing the luminance of pixels included in the image. For example, if a certain color space has the luminance channel, when the image is expressed in the certain color space, a luminance value may be represented for each of the pixels included in the image.

In the present disclosure, “luminance information” may refer to brightness information of the pixels included in the image. An electronic device according to an embodiment of the present disclosure may obtain the luminance information for the image through the luminance channel.

In the present disclosure, a “weight” is a component included in a neural network model, and may refer to a value applied to input data.

In the present disclosure, a “kernel” is a convolution filter included in a convolution layer, and may refer to a matrix including weight elements. Hereinafter, in the present disclosure, the kernel may be replaced with the “weight”.

In the present disclosure, the “neural network model” may refer to a neural network trained to perform a target operation.

In the present disclosure, a “feature” may refer to a result of extracting from the input data for an operation of the neural network model. The “feature” may refer to a feature map, and may refer to an output generated through a convolution operation in a convolutional neural network.

In the present disclosure, the “feature map” may refer to an output value generated through the convolution operation in the convolutional neural network. Hereinafter, the feature map may be replaced with a feature vector or a feature value.

In the present disclosure, “deep learning” may refer to performing machine learning by using an artificial neural network having multiple layers.

In the present disclosure, “machine learning” may refer to an algorithm that enables a computer to learn from data.

In the present disclosure, “learning” may refer to updating the neural network model to perform an operation according to a specific purpose.

In the present disclosure, “image registration” may refer to a process of transforming a plurality of frames obtained from different viewpoints or perspectives with respect to one object and representing the transformed frames in one coordinate system.

In the present disclosure, “bilinear upsampling” is an upsampling method used in an image processing process, and may refer to a method using linear interpolation.

In the present disclosure, a “convolutional neural network (CNN)” is a deep learning neural network model, and may refer to a deep learning neural network model including a convolution layer that extracts the feature.

In the present disclosure, “depth to space (d2s)” may refer to a process of unfolding one pixel having a plurality of channels into a plurality of pixels having one channel.

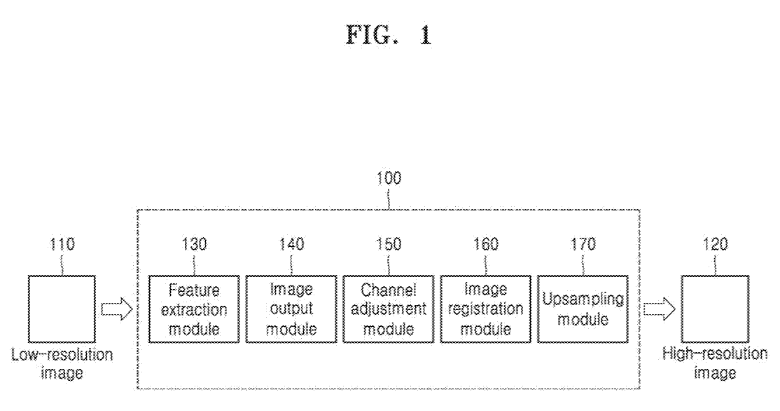

FIG. 1 is a diagram illustrating an operation of processing an image by using a neural network model as a plurality of modules, according to an embodiment of the present disclosure.

In an embodiment of the present disclosure, an electronic device 100 for processing an image may process an image by using an image processing network. The image processing network may adjust image resolution. The resolution is a degree of detail of a displayed image, and may be expressed by the number of all pixels expressed on a screen or the number of pixels per unit length.

An operation in which the electronic device 100 adjusts the image resolution by using the image processing network may be described in units of software responsible for a specific function or role. Modules (e.g., 130 to 170) illustrated in FIG. 1 may be classifications of operations performed by a processor by executing instructions stored in a memory according to functions. Accordingly, operations described below as being performed by the modules (e.g., 130 to 170) illustrated in FIG. 1 may be considered as being actually performed by the processor.

Image super-resolution technology is for improving resolution and quality when processing a low-resolution image or a pixelated image, and in the present disclosure, the image resolution is enhanced by using the image processing network. The present disclosure discloses a method of enhancing resolution through image registration by using a plurality of frames in an image, together with a case of enhancing resolution by using a single image.

In an embodiment of the present disclosure, the electronic device 100 may be an electronic device capable of processing and outputting a video or an image. The electronic device 100 may be implemented in various forms including a display. For example, the electronic device 100 may be implemented as various electronic devices such as a television (TV), a mobile phone, a tablet personal computer (PC), a digital camera, a camcorder, a laptop computer, a desktop computer, an e-book terminal, a digital broadcasting terminal, a personal digital assistant (PDA), a portable multimedia player (PMP), a navigation device, an MP3 player, a wearable device, and the like. The electronic device 100 may include a plurality of modules (e.g., 130 to 170) for performing resolution correction by using luminance information of an image.

The electronic device 100 may generate a high-resolution image 120 from a low-resolution image 110 through operations of the plurality of modules (e.g., 130 to 170). The electronic device 100 may perform the resolution correction using the luminance information of the image through the plurality of modules (e.g., 130 to 170) using the neural network model.

In an embodiment of the present disclosure, the electronic device 100 may extract the luminance information from the low-resolution image 110 obtained from the image through a luminance channel. The low-resolution image 100 may include an RGB image, but is not limited thereto. In an embodiment, the electronic device 100 may convert the RGB image into a color space including the luminance channel. The color space including the luminance channel may include YUV, YCoCg, YCbCr, or the like, but is not limited thereto. The luminance channel may refer to a channel representing the luminance of pixels included in the image, the luminance information may refer to brightness information of the pixels included in the image, and the electronic device 100 may obtain the luminance information for the image through the luminance channel.

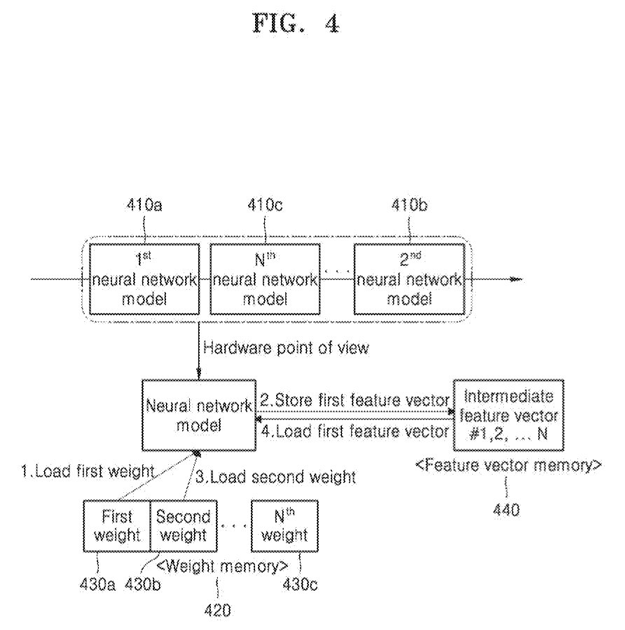

In an embodiment, the electronic device 100 may learn a relationship between input data and output data through learning for performing resolution enhancement by using the neural network model. According to an embodiment, the electronic device 100 may perform the learning by using a pre-existing low-resolution image and a pre-existing high-resolution image. When the learning for the resolution enhancement is completed for the neural network model, the electronic device 100 may determine a weight or a kernel applied to the input data of the neural network model and may store the weight or the kernel in the memory. The electronic device 100 may determine a plurality of weights or kernels to use the neural network model a plurality of times. In order to obtain the output data corresponding to the input data by using the neural network model, the electronic device 100 may load the weight or the kernel from the memory and may apply the weight or the kernel to the neural network model. The neural network model may process the input data according to the weight applied to the neural network model. Hereinafter, an operation of loading the stored weight or kernel and storing a feature vector will be described in detail with reference to FIG. 4.

In an embodiment, the electronic device 100 may obtain a feature vector corresponding to the luminance information by using the neural network model included in a feature extraction module 130. The neural network model may include a convolutional neural network (CNN), but is not limited thereto. According to an embodiment, when the luminance information is input to the neural network model included in the feature extraction module 130, the neural network model may extract a vector including a feature of the input luminance information as the feature vector. The feature extraction module 130 may extract the feature vector corresponding to the luminance information by using the neural network model to which the weight or the kernel is applied. In an embodiment, the feature extraction module 130 may load the weight or the kernel from the memory and may apply the weight or the kernel to the neural network model to extract the feature vector. Hereinafter, for convenience of description, the neural network model that extracts the feature vector corresponding to the luminance information is referred to as a “first neural network model”.

According to an embodiment of the present disclosure, the electronic device 100 may include a plurality of neural network models, and the plurality of neural network models included in the electronic device 100 may have the same connection structure. In the present disclosure, the phrase “neural network models have the same connection structure” may mean that a connection structure of layers included in the neural network models, a processing order of operations performed by the neural network models, and the like are the same.

When the connection structures of the neural network models are the same, the neural network models may be implemented by using a hardware chip having the same structure. Accordingly, the electronic device 100 according to an embodiment of the present disclosure may implement various neural network models by changing and applying weights to the neural network model (hardware chip) having the same structure. A first neural network model to a third neural network model described below may be models implemented by differently applying weights to the hardware chip having the same structure as described above. Accordingly, the neural network models included in the electronic device 100 according to an embodiment of the present disclosure may be implemented by using one hardware chip, or may be implemented by using two or more hardware chips having the same structure. The electronic device 100 according to an embodiment of the present disclosure may implement the plurality of neural network models by differently applying weights by using one hardware chip.

In an embodiment, the feature extraction module 130 may repeatedly perform an operation of extracting the feature vector. For example, the electronic device 100 may extract a first feature vector corresponding to the luminance information by using the neural network model, and may extract a second feature vector corresponding to the first feature vector by using a neural network model having the same connection structure. The feature extraction module 130 may store the extracted feature vector in the memory. Hereinafter, for convenience of description, a neural network model that has the same connection structure as the first neural network model and extracts a feature vector corresponding to the feature vector is referred to as a “third neural network model”.

In an embodiment, the electronic device 100 may obtain an output image corresponding to the feature vector by using a neural network model included in an image output module 140. The image output module 140 may obtain the output image from the feature vector by applying a weight or a kernel to the neural network model. The neural network model included in the image output module 140 may have the same connection structure as the neural network model included in the feature extraction module 130. In an embodiment, the neural network model that outputs the feature vector and the neural network model that outputs the image may have the same structure in terms of hardware. The electronic device 100 may obtain different output values (e.g., feature vector, the output image, etc.) by applying different weights or kernels to the neural network models having the same connection structure. Hereinafter, for convenience of description, a neural network model that has the same connection structure as the first neural network model and obtains the output image corresponding to the feature vector is referred to as a “second neural network model”.

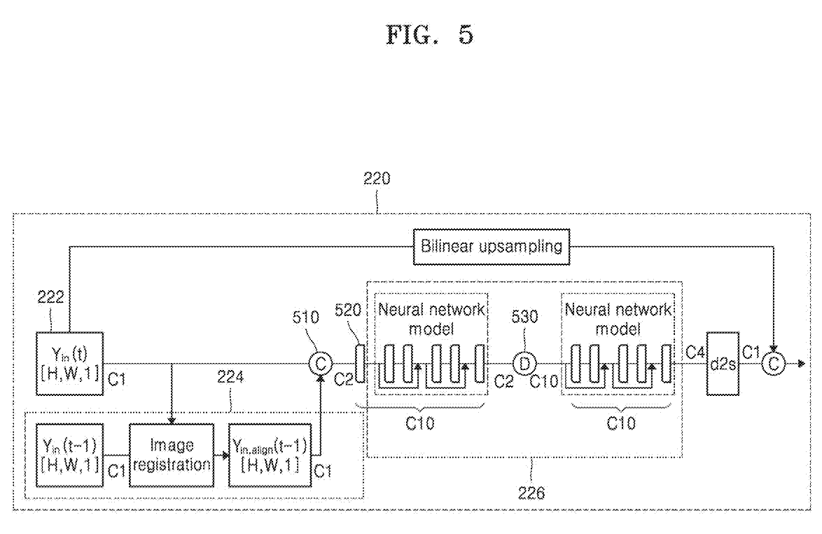

In an embodiment, the electronic device 100 may adjust the number of luminance channels for obtaining the luminance information or the number of channels of the feature vector through a channel adjustment module 150. In an embodiment, the electronic device 100 may adjust the number of channels through the channel adjustment module 150 in order to use the image processing network. The number of channels may refer to the number of components or color channels constituting the image. The channel adjustment module 150 may adjust the number of luminance channels for obtaining the luminance information or adjust the number of channels of the feature vector according to the number of input channels of the neural network model. The channel adjustment module 150 of the electronic device 100 may further include layers before and after the neural network model to adjust the number of channels. The channel adjustment module 150 may adjust the number of channels by using the layers additionally included before and after the neural network model. The electronic device 100 may use duplication or a null value to adjust the number of channels. The electronic device 100 may perform depth to space (d2s) to adjust the number of channels. The d2s refers to a process of unfolding one pixel having a plurality of channels into a plurality of pixels having one channel. Hereinafter, a method of adjusting the number of channels will be described in detail with reference to FIG. 5.

In an embodiment, the electronic device 100 may perform image registration through the image registration module 160 to obtain the feature vector. The image registration is a process of transforming a plurality of frames obtained from different viewpoints or perspectives with respect to one object and representing the transformed frames in one coordinate system. When resolution is reduced due to shaking or movement of a specific object included in the low-resolution image, the image registration module 160 may clearly correct the specific object by using an image of a previous frame including the specific object. The image registration module 160 is required to match coordinates of the image of the previous frame with coordinates of the low-resolution image in order to use the image of the previous frame to perform resolution correction.

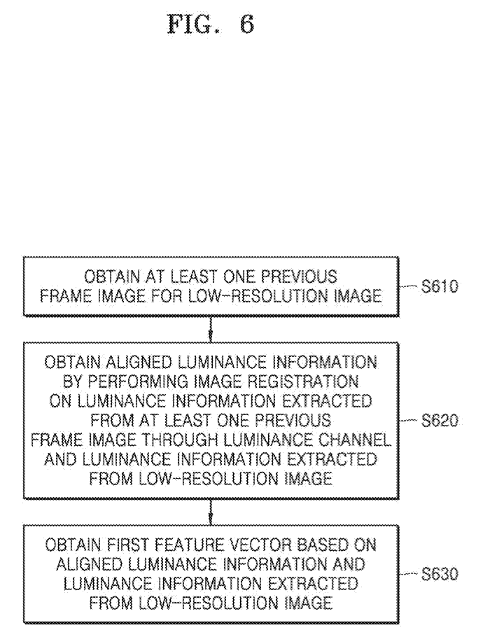

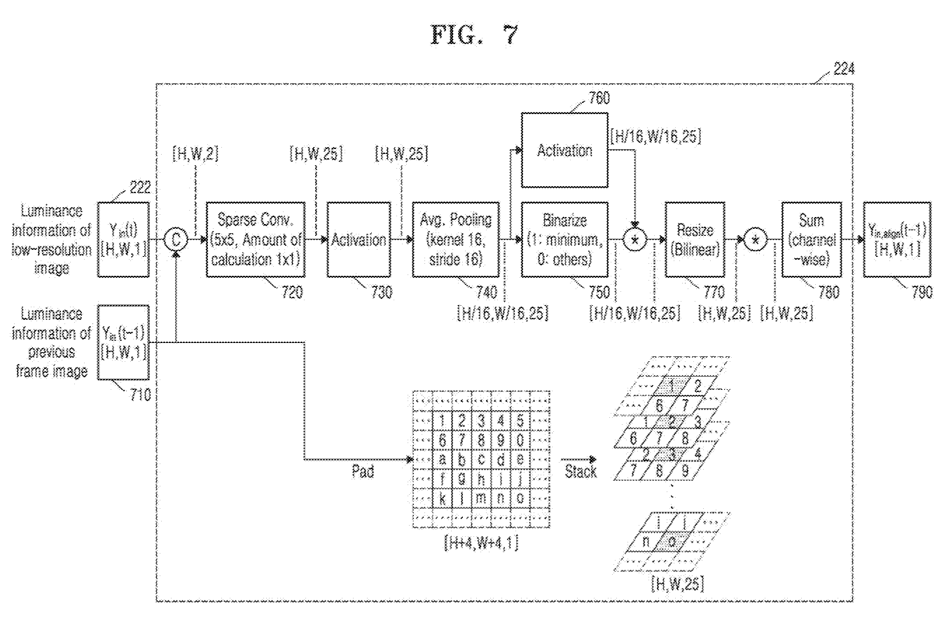

The image registration module 160 may perform the image registration based on luminance information extracted from the image of the previous frame for the low-resolution image and luminance information for the low-resolution image. The image registration module 160 may obtain aligned luminance information based on the luminance information extracted from the image of the previous frame and the luminance information extracted from the low-resolution image. The image registration module 160 may provide the aligned luminance information to the feature extraction module 130, and the feature extraction module 130 may obtain the feature vector by using the aligned luminance information. Hereinafter, a detailed image registration process will be described with reference to FIGS. 6 and 7.

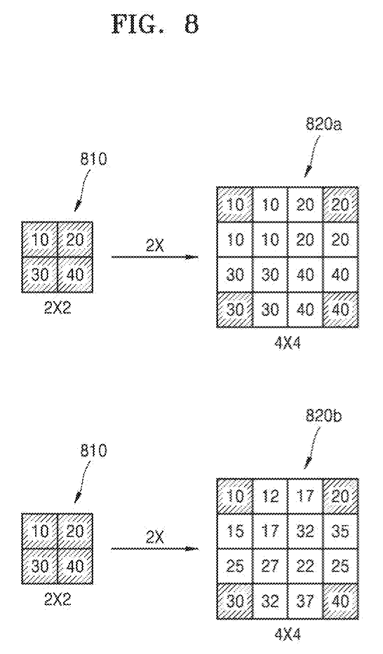

In an embodiment, the electronic device 100 may generate the high-resolution image 120 by using the output image obtained through the neural network model. The high-resolution image 120 may include, but is not limited to, an RGB image. The electronic device 100 may use an upsampling module 170 to obtain the high-resolution image 120. The upsampling may refer to a process of increasing a size or resolution of an image in image processing. As the size of the image is increased, pixels included in the image are added. The upsampling module 170 may perform bilinear upsampling, which is one of upsampling methods. The bilinear upsampling is a technique used in an image processing process, and refers to a method of performing upsampling by using linear interpolation. Hereinafter, a detailed method will be described with reference to FIG. 8.

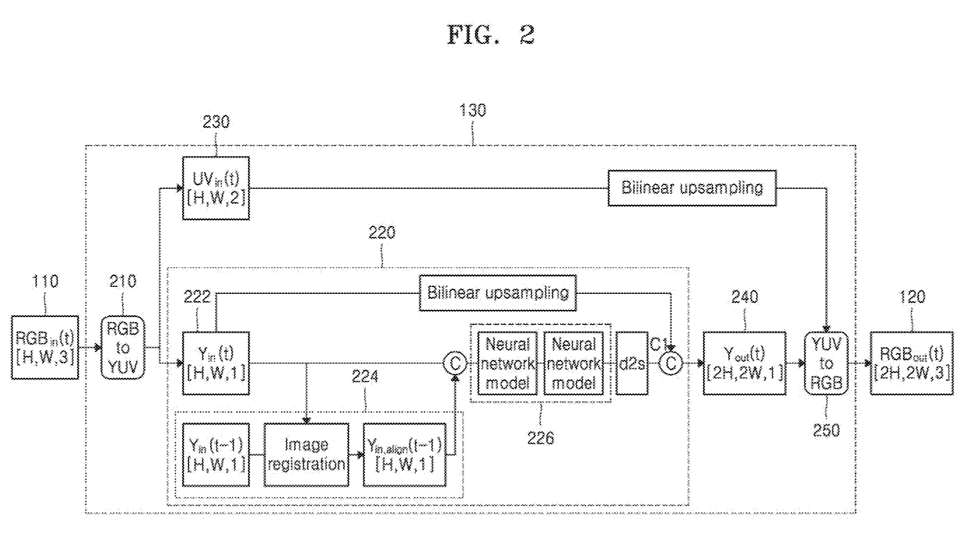

FIG. 2 is a diagram illustrating a specific operation of processing an image by using a neural network model, according to an embodiment of the present disclosure.

Referring to FIG. 2, an operation of the electronic device 100 for adjusting image resolution by using an image processing network will be described in units of hardware. The low-resolution image 110, which is an input value of the electronic device 100 for image processing, and the high-resolution image 120, which is an output value, may refer to RGB images having three color channels. The low-resolution image 110 and the high-resolution image 120 may have values of [H, W, 3] and [2H, 2W, 3], respectively. The present disclosure discloses a method of enhancing image resolution in an upsampling process of an image in which the high-resolution image 120 has the same number of channels as the low-resolution image 110, but height (H) and width (W) values are doubled.

In an embodiment of the present disclosure, the image processing network of the electronic device 100 may use a neural network model several times to enhance the resolution of the image, and the neural network model may include a convolutional neural network (CNN), but is not limited thereto. The CNN is a deep neural network designed to process structured data such as images and videos. The CNN is used for image classification, object detection, image generation, image processing, and the like, and automatically learns and extracts hierarchical features from visual data. In an embodiment, the electronic device 100 may perform resolution enhancement by using a neural network model having the same connection structure. The neural network model having the same connection structure may have the same structure in hardware, but input and output data may be different as applied values such as weights are different.

In an embodiment, the neural network model may learn a relationship between data through learning by using the input data and the output data in advance. The neural network model may determine a weight or a kernel applied to the input data as a result of the learning for the resolution enhancement. The weight may refer to a value applied to the input data as a component included in the neural network model, and the kernel may refer to a matrix including the weight as an element as a convolution filter. The neural network model may process the input data according to the weight applied to the neural network model.

In an embodiment, the image processing network of the electronic device 100 may convert the low-resolution image 110 (e.g., an RGB image), which is the input value, into a YUV image including a luminance channel for obtaining luminance information. The YUV image is only an example of an image including the luminance channel, and may be replaced with another image including the luminance channel such as YCoCg or YCbCr. The YUV image includes one luminance channel (Y) and channels representing blue (U) and red (V) as two chrominance components. The YCoCg image includes one luminance channel (Y) and channels representing orange (Co) and green (Cg) as two chrominance components. YCbCr may refer to YUV in a digital format. The luminance information may refer to brightness information of pixels included in the image, and may be obtained through the luminance channel. The electronic device 100 may divide and extract, a YUB image 210 that is a low-resolution image, input luminance information 222 obtained through the luminance channel and information 230 including two channels other than the luminance information.

In an embodiment, the image processing network of the electronic device 100 may perform resolution enhancement 220 by using the luminance information. The image processing network of the electronic device 100 may perform the resolution enhancement by using an image of a previous frame. When resolution of a specific object in an image decreases due to shaking or movement, the image processing network may clarify the specific object or enhance the resolution of the image by using the image of the previous frame. In order to use the image of the previous frame, an operation of matching coordinates of the previous frame and coordinates of a low-resolution image frame is required.

The image processing network may perform image registration 224 based on the image of the previous frame of the low-resolution image and the low-resolution image. The image registration may refer to a process of transforming a plurality of frames obtained from different viewpoints with respect to one object and representing the transformed frames in one coordinate system. Hereinafter, a detailed operation will be described in detail with reference to FIGS. 6 and 7.

In an embodiment, the image processing network of the electronic device 100 may include a plurality of neural network models 226. The plurality of neural network models 226 may have the same connection structure, which may mean having the same hardware configuration. The plurality of neural network models 226 having the same connection structure may process the input data by applying different weights. The electronic device 100 may use the neural network model two or more times by applying different weights for the resolution enhancement. The neural network model may output a feature vector by applying the weight to the luminance information as the input value. In an embodiment, the neural network model having the same connection structure may output an image by applying the weight using the feature vector as the input value. The neural network model may apply a different weight for each input. Alternatively, the neural network model may apply a kernel having different weights as parameters for each input. The neural network model may load the weight stored through a learning model for the resolution enhancement from a memory and apply the loaded weight to the input value. Hereinafter, a detailed method will be described with reference to FIG. 4.

In an embodiment, the image processing network of the electronic device 100 may additionally include at least one layer before and after the neural network model. The image processing network may adjust the number of channels by additionally using at least one layer in addition to layers included in the neural network model. In an embodiment, the neural network model may adjust the number of channels by using a layer. When the neural network model is used several times, the number of channels may be adjusted by adding a layer between the plurality of neural network models.

In an embodiment, an output image obtained by the image processing network of the electronic device 100 by using the neural network model may include output luminance information. The image processing network may convert the output image into output luminance information by performing depth to space (d2s) on the output image. The d2s may refer to a process of unfolding one pixel having a plurality of channels to a plurality of pixels having one channel. For example, the output image obtained by using the neural network model may refer to an image having four channels and including the luminance information. The electronic device 100 may obtain the output luminance information of one channel by performing the d2s on the output image.

The image processing apparatus may obtain upsampled output luminance information 240 by performing bilinear upsampling on the input luminance information 222 and the output luminance information. The image processing network may obtain a YUV image by using the upsampled output luminance information 240 and the information 230 including the channels other than the luminance information, and may convert the YUV image into an RGB image 250. The image processing network may obtain the YUV image by performing the bilinear upsampling on the upsampled output luminance information 240 and the information 230 including the channels other than the luminance information, and may convert the YUV image into the RGB image 250. Hereinafter, a bilinear upsampling process will be described in detail with reference to FIG. 8. The electronic device 100 may obtain the high-resolution image 120 as a result of image conversion.

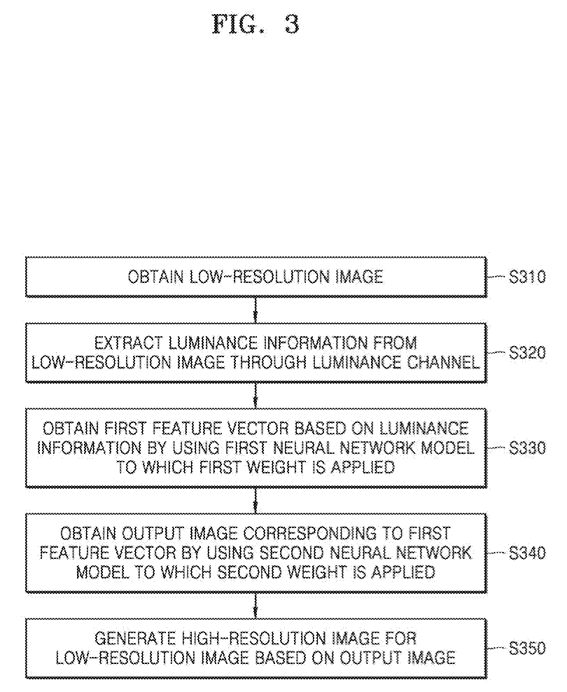

FIG. 3 is a flowchart illustrating an operation of processing an image by using a neural network model, according to an embodiment of the present disclosure.

In operation S310, the electronic device 100 may obtain a low-resolution image. The low-resolution image may include an RGB image, but is not limited thereto.

For example, the low-resolution image may have a value of [H, W, 3], and a high-resolution image output as a result of resolution enhancement by using the neural network model may have a value of [2H, 2W, 3]. That is, a clearer high-resolution image may be obtained by having four times more pixels through resolution correction using the low-resolution image.

According to an embodiment, the electronic device 100 may obtain at least one previous frame image together with the low-resolution image to perform image registration. The electronic device 100 may obtain the previous frame image of the obtained low-resolution image as the image is obtained from a video. Hereinafter, the image registration will be described in detail with reference to FIGS. 6 and 7.

In operation S320, the electronic device 100 may extract luminance information from the low-resolution image through a luminance channel. The luminance channel is one of channels constituting the color space, and may refer to a channel representing luminance of pixels included in the image. The luminance information may refer to brightness information of the pixels included in the image, and may be obtained through the luminance channel.

In an embodiment, the electronic device 100 may convert information about the color space into an image including the luminance information. For example, the electronic device 100 may convert the RGB image into a YUV image. The YUV image is only an example of the image including the luminance channel, and may be replaced with an image including the luminance channel such as YCbCr or YCoCg. The electronic device 100 may extract the luminance information from the converted YUV image through the luminance channel.

In an embodiment, the electronic device 100 may process the luminance information by using at least one previous frame image for the low-resolution image for the resolution enhancement. As the low-resolution image is obtained from the video, the electronic device 100 may use the image of the previous frame to enhance resolution according to movement of a specific object. In order to use the image of the previous frame, a procedure of matching coordinates of the previous frame with coordinates of the low-resolution image is required for the electronic device 100. The electronic device 100 may obtain at least one aligned luminance information by performing the image registration on the luminance information obtained through the luminance channel in the at least one previous frame and the luminance information of the low-resolution image. The image registration refers to a process of transforming the low-resolution image and the at least one previous frame image for the same object and representing them in one coordinate system. Hereinafter, a specific method will be described with reference to FIGS. 6 and 7.

In operation S330, the electronic device 100 may obtain a first feature vector based on the luminance information by using a first neural network model to which a first weight is applied. The neural network model may include a CNN, but is not limited thereto. The feature vector may refer to a vector value extracted from input data for an operation of the neural network model. In an embodiment, when the luminance information is input to the first neural network model, the first neural network model may output a vector including a feature of the input luminance information as the first feature vector by applying the first weight. In an embodiment, the first weight may refer to a kernel having a plurality of weights as elements.

In an embodiment, the electronic device 100 may obtain the first feature vector by using the neural network model several times. In an embodiment, the electronic device 100 may use the neural network model a plurality of times to obtain the first feature vector. The electronic device 100 may use different weights when using the neural network model the plurality of times. In an embodiment, the electronic device 100 may use a plurality of neural network models to obtain the first feature vector. The plurality of neural network models may have the same connection structure, and the electronic device 100 may apply a different weight for each neural network model.

According to an embodiment, the electronic device 100 may learn a relationship between the input data and output data through learning for the resolution enhancement, may determine at least one weight, and may store the determined weight in a memory. In an embodiment, the electronic device 100 may determine at least one kernel having at least one weight as an element and may store the kernel in the memory. The electronic device 100 may determine a weight or a kernel to be applied to the neural network model among the stored at least one weight according to repeated execution of the neural network model, and may load the weight or the kernel from the memory. The electronic device 100 may store feature vectors, which are intermediate output values obtained by using the neural network model to which the at least one weight or kernel is applied, in the memory. Hereinafter, a specific repeated operation will be described in detail with reference to FIG. 4.

In an embodiment, the electronic device 100 may adjust the number of luminance channels according to the number of input channels of the neural network model. In an embodiment, the electronic device 100 may adjust the number of luminance channels by using a layer added in front of the neural network model. The electronic device 100 may duplicate values or may use a null value to adjust the number of luminance channels. Hereinafter, a specific channel adjustment method will be described with reference to FIG. 5.

In operation S340, the electronic device 100 may obtain an output image corresponding to the first feature vector by using a second neural network model to which a second weight is applied. The electronic device 100 may obtain the output image by using a neural network model having the same connection structure as the neural network model that obtains the feature model. The neural network model having the same connection structure refers to a neural network model having the same hardware configuration, and internal values such as applied weights or kernel values may be different. The second weight may refer to a kernel having a plurality of weights as elements. In an embodiment, the electronic device 100 may apply different weights to the first neural network model and the second neural network model, respectively. The first weight and the second weight may have different values.

According to an embodiment, the electronic device 100 may obtain the output image corresponding to the first feature vector by using the second weight different from the first weight. In order to use the first feature vector as an input value of the neural network model, the electronic device 100 may adjust the number of channels of the first feature vector according to the number of channels of the neural network model. The electronic device 100 may adjust the number of channels of the first feature vector by duplicating a value of the first feature vector or inputting a null value into an empty channel.

For example, when the number of channels of the neural network model is 10 and the number of channels of the first feature vector is 2, the number of channels may be adjusted to 10 by repeating two values four times, or the number of channels of the first feature vector may be adjusted by inputting null values into the remaining eight channels. The electronic device 100 may additionally include a layer for matching the number of channels of the first feature vector with the number of channels of the neural network model.

In an embodiment, the output image may refer to an image C4 including luminance information having four channels, and d2s may be performed on the output image. The d2s may refer to a process of unfolding one pixel having a plurality of channels into a plurality of pixels having one channel. For example, one pixel having four channels may be unfolded into four pixels having one channel.

In operation S350, the electronic device 100 may generate a high-resolution image for the low-resolution image based on the output image. According to an embodiment, the electronic device 100 may obtain the high-resolution image in which H and W values are twice those of the low-resolution image.

According to an embodiment, the electronic device 100 may obtain upsampled output luminance information by performing bilinear upsampling on output luminance information of the output image obtained in operation S340 and the input luminance information. The upsampling may refer to a process of increasing a size or resolution of an image in image processing. The bilinear upsampling is one of upsampling methods used in an image processing process, and refers to upsampling using linear interpolation. The electronic device 100 may obtain a YUV image by using the upsampled output luminance information and information including channels other than the luminance information, and may convert the YUV image into an RGB image. The electronic device 100 may obtain a YUV image by performing bilinear upsampling on information including a channel other than the upsampled output luminance information and the luminance information, and convert the YUV image into the RGB image. Hereinafter, a bilinear upsampling process will be described in detail with reference to FIG. 8.

FIG. 4 is a diagram illustrating an operation of processing an image by using a value stored in a memory for a neural network model, according to an embodiment of the present disclosure.

Referring to FIG. 4, the electronic device 100 may use a plurality of neural network models (e.g., 410a, 410b, and 410c) for resolution enhancement. The plurality of neural network models may have the same connection structure, which may mean that they are identical in terms of hardware. The electronic device 100 may apply different values (e.g., different weights, kernel values, etc.) inside the plurality of neural network models. The electronic device 100 may include a weight memory 420 storing weight values and a feature vector memory 440 storing feature vectors. In the present disclosure, when the plurality of neural network models having the same connection structure are used, it may be advantageous for memory allocation of the electronic device 100 as an intermediate output value is a feature vector rather than an image.

The electronic device 100 may obtain a plurality of output values through the plurality of neural network models (e.g., 410a, 410b, and 410c) having the same connection structure by recursively using one neural network model in terms of hardware. As an operation is performed by applying different weights to the neural network models having the same connection structure, the electronic device 100 may effectively utilize the neural network models by using a small amount of space in terms of hardware.

In an embodiment, the neural network model may generate a mapping between data through deep learning training using input data and output data in advance. The neural network model may determine a weight or a kernel applied to the input data as a result of the training. The weight may refer to a value applied to the input data as a component included in the neural network model, and the kernel may refer to a matrix including the weight as an element as a convolution filter.

The electronic device 100 may learn a relationship between an input value and an output value through training for resolution enhancement, may determine a plurality of weights (e.g., 430a, 430b, and 430c) to be applied to the neural network model, and may store the plurality of weights in the weight memory 420. According to an embodiment, the electronic device 100 may determine a kernel, which is a matrix having a plurality of weights as elements, through the training for resolution enhancement, and may store the kernel in a memory. The plurality of weights (e.g., 430a, 430b, and 430c) may have the same value or different values as a result of the training.

To use the neural network model, the electronic device 100 may load one weight among the plurality of weights stored in the weight memory 420, and may store a feature vector, which is an intermediate output value obtained by applying the loaded weight to the neural network model, in the feature vector memory 440. To use the plurality of neural network models, the electronic device 100 may load one weight among the plurality of weights stored in the weight memory 420, and may load an intermediate feature vector from the feature vector memory 440 to use the intermediate feature vector as an input value of the neural network model to which the loaded weight is applied. The electronic device 100 may store a plurality of intermediate feature vectors obtained by using the plurality of neural network models in the feature vector memory 440.

For example, to use a first neural network model based on luminance information extracted through a luminance channel from a low-resolution image that is an input value, the electronic device 100 may 1) load a first weight 430a from the weight memory 420. The electronic device 100 may obtain a first feature vector based on the luminance information by using the first neural network model to which the first weight is applied. In an embodiment, the electronic device 100 may obtain the first feature vector corresponding to the luminance information. In an embodiment, the electronic device 100 may obtain a second feature vector corresponding to the luminance information by using the plurality of neural network models, and may obtain the first feature vector corresponding to the second feature vector. The electronic device 100 may 2) store the obtained first feature vector in the feature vector memory 440. To use the plurality of neural network models, the electronic device 100 may repeatedly load a weight to be applied to a feature vector, which is an intermediate output value, from the weight memory, and may obtain an intermediate feature vector. The electronic device 100 may 3) load a second weight 430b from the weight memory 420 to obtain an output image by using a second neural network model. The electronic device 100 may 4) load the first feature vector from the feature vector memory 440 to use the second neural network model to which the second weight 430b is applied. The electronic device 100 may obtain an output image corresponding to the first feature vector loaded from the feature vector memory 440 in the second neural network model to which the second weight 430b is applied.

In an embodiment, the number of neural network models used by the electronic device 100 for resolution enhancement may be changed, and may be determined in a resolution enhancement training process of determining a weight. According to the determined number of iterations, the number of weights stored in the weight memory 420 and the number of intermediate feature vectors to be stored in the feature vector memory 440 may be determined. Weights to be applied to the plurality of neural network models may be determined based on an order of weights obtained as a result of the training.

FIG. 5 is a diagram for describing a layer for adjusting the number of channels, according to an embodiment of the present disclosure.

Referring to FIG. 5, a block 220 for performing resolution enhancement by using luminance information in an image processing network of the electronic device 100 of FIG. 2 is illustrated in detail.

In an embodiment, each neural network model included in the plurality of neural network models 226 may include a plurality of layers. The plurality of layers may include a convolution layer, a pooling layer, a fully connected layer, and the like, but are not limited thereto. The convolution layer performs a convolution operation on input data, and detects a feature or a pattern by applying a weight or a kernel to an input. The pooling layer performs downsampling to reduce a spatial dimension of a feature map generated by the convolution layer. The fully connected layer is also referred to as a dense layer, and connects all neurons of a previous layer to a current layer.

The block 220 for performing resolution enhancement by using luminance information may perform the image registration 224 by using the input luminance information 222 obtained from a low-resolution image through a luminance channel and luminance information obtained from a previous frame for the low-resolution image. The block 220 for performing resolution enhancement by using luminance information may obtain aligned luminance information 510 as a result of the image registration 224. A process of the image registration 224 will be described in detail with reference to FIGS. 6 and 7.

In an embodiment, the block 220 for performing resolution enhancement by using luminance information may require adjustment of the number of channels in order to use the plurality of neural network models 226. In an embodiment, the plurality of neural network models 226 may refer to a plurality of neural network models having the same connection structure. The electronic device 100 may apply different weights to the plurality of neural network models 226 having the same connection structure. Based on the number of input channels of a neural network model included in the plurality of neural network models 226, the block 220 for performing resolution enhancement by using luminance information may adjust the number of channels of the luminance information, the aligned luminance information 510, or a feature vector.

In an embodiment, the block 220 for performing resolution enhancement by using luminance information may include an additional layer 520 for channel adjustment. The additional layer 520 may be added before or after each neural network model included in the plurality of neural network models 226.

For example, the number of channels of the aligned luminance information 510 obtained as the result of the image registration 224 is 2. When the number of input channels of a neural network model used for the plurality of neural network models 226 is 10, the number of channels of the aligned luminance information 510 may be adjusted according to the number of input channels of the neural network model. The number of channels of the aligned luminance information 510 may be adjusted by the additional layer 520 added before the plurality of neural network models 226.

Alternatively, the number of channels of the aligned luminance information 510 may be adjusted by duplicating a value or adding a null value. For example, when the number of channels of the aligned luminance information 510 is 2 and the number of input channels of the neural network model is 10, the number of channels may be adjusted to 10 by duplicating the value included in the aligned luminance information 510, or the number of channels may be adjusted by inputting a null value to the remaining channels. This is only an example of a method of adjusting the number of channels of the aligned luminance information 510, and is not limited thereto.

The number of channels of the feature vector obtained by using the neural network model may be adjusted according to the number of input channels of the neural network model. For example, the number of channels of the feature vector obtained by using the neural network model is 2. In order to adjust the number of channels of the feature vector to match the number of input channels of the neural network model, the feature vector value may be duplicated or a null value may be used. For example, the number of channels of the feature vector may be adjusted by duplicating two channels of the feature vector to make 10 channels or by adding a null value to channels other than the two channels. This is only an example of a method of adjusting the number of channels of the feature vector, and is not limited thereto.

In an embodiment, the additional layer 520 for adjusting the number of channels may be added to a rear portion in addition to a front portion of the plurality of neural network models 226 to adjust the channels. In an embodiment, the additional layer 520 may include a plurality of layers.

FIG. 6 is a flowchart for describing image registration performed for image processing, according to an embodiment of the present disclosure.

Referring to FIG. 6, a flowchart for a method of performing image registration by using an image of a previous frame of a low-resolution image to obtain a first feature vector in operation S330 is illustrated. The image registration may refer to a process of transforming a plurality of frames obtained from different viewpoints or perspectives with respect to one object and representing the transformed frames in one coordinate system.

When resolution of an image is reduced due to shaking or movement of a specific object included in the low-resolution image obtained from a video, the electronic device 100 may clarify the specific object or enhance the resolution of the image by using the image of the previous frame. In order to use the image of the previous frame, an operation of matching coordinates of frames is required. Accordingly, the electronic device 100 may perform the image registration for matching coordinates of the previous frame and a current frame. Hereinafter, a detailed operation of the electronic device 100 will be described.

In operation S610, the electronic device 100 may obtain at least one image of a previous frame for a low-resolution image. Because the low-resolution image is an image obtained from a video and is one of consecutive images, the electronic device 100 may obtain the image of the previous frame for the low-resolution image.

In an embodiment, the electronic device 100 may convert the image of the previous frame to include a luminance channel. The image of the previous frame may be an RGB image, and the electronic device 100 may convert the RGB image into a YUV image including luminance information. YUV is only an example of an image including luminance information, and is not limited thereto. In an embodiment, the electronic device 100 may extract the luminance information from other information through the luminance channel in the YUV image.

In operation S620, the electronic device 100 may obtain aligned luminance information by performing image registration on the luminance information extracted from the at least one image of the previous frame through the luminance channel and the luminance information extracted from the low-resolution image.

In an embodiment, the electronic device 100 may extract the luminance information from the image of the previous frame through the luminance channel. The electronic device 100 may perform the image registration to match coordinates of the luminance information extracted from the image of the previous frame and the luminance information extracted from the low-resolution image. Hereinafter, the image registration will be described in detail with reference to FIG. 7.

In operation S630, the electronic device 100 may obtain a first feature vector based on the aligned luminance information and the luminance information extracted from the low-resolution image.

In an embodiment, the electronic device 100 may perform a concatenation function on the aligned luminance information obtained in operation S620 and the luminance information extracted from the low-resolution image. The concatenation function means connecting a plurality of matrices. For example, when the luminance information extracted from the low-resolution image and the aligned luminance information have one channel, the two pieces of information are connected to have two channels by performing the concatenation function.

In an embodiment, the electronic device 100 may perform the concatenation function on the luminance information extracted from the low-resolution image and the aligned luminance information, and then may obtain a first feature function by using a neural network model to which a first weight is applied. The electronic device 100 may adjust the number of channels of the aligned luminance information on which the concatenation function is performed to match the number of input channels of the neural network model. A method of adjusting the number of channels is described above with reference to FIG. 5.

FIG. 7 is a diagram illustrating image registration performed for image processing, according to an embodiment of the present disclosure.

Referring to FIG. 7, a process of obtaining aligned luminance information through image registration by using a low-resolution image and a previous frame image for the low-resolution image is illustrated. The image registration refers to a process of aligning two or more images with respect to the same scene or object captured at different times or viewpoints.

A process of obtaining aligned luminance information 790 through image registration by using the luminance information 222 of the low-resolution image and luminance information 710 of at least one previous frame image of the low-resolution image is illustrated.

A concatenation function may be performed on the luminance information 222 of the low-resolution image and the luminance information 710 of the previous frame image. The concatenation function means connecting a plurality of columns. When the concatenation function is performed on two pieces of information each having a value of [H, W, 1], [H, W, 2] is output as an output value.

Sparse convolution 720 is performed on the output value of [H, W, 2] obtained as a result of the concatenation function. The sparse convolution is a variant of convolution used in a CNN when input data has many zero values, using a sparse convolution kernel value. The sparse convolution performs a convolution operation while skipping an area in which an input value is 0. The sparse convolution reduces the amount of computation and memory usage by processing only non-zero elements among input values. For example, a sparse convolution kernel includes 25 matrices in which only one value among elements of a 5x5 matrix has “1” and the others all have “0”. As a result of performing the sparse convolution 720, [H, W, 25] is output.

The electronic device 100 applies an activation function 730 to the output [H, W, 25] of the sparse convolution 720. The activation function performs a determination as to whether a corresponding input value plays an important role in a neural network. By using the activation function, nonlinearity may be introduced into the network, and complex patterns and relationships of data may be learned. The activation function may include a sigmoid function, a hyperbolic tangent function (Tanh function), a rectified linear unit, and Leaky ReLU. As a result of performing the activation function, [H, W, 25], in which the importance of an input value is determined based on a weight input, is output.

Average pooling 740 may be performed on the output [H, W, 25] of the activation function 730. The average pooling 740 is a downsampling operation that reduces a spatial size of an image. By performing the average pooling, a low-resolution image may be generated by reducing the spatial resolution of the image. By performing the average pooling, [H/16, W/16, 25] generating a downsampled feature map by using an average value of values of a feature map may be output.

The electronic device 100 may apply a binarization function 750 and an activation function 760 to the output [H/16, W/16, 25] of the average pooling 740. The binarization function is a function for simplifying data by generating a binary version of an image in which pixel values correspond to 0 and 1. The binarization function improves contrast and is used as a preprocessing step of feature detection, image segmentation, or image processing functions. As the binarization function 750 and the activation function 760 are performed on the output [H/16, W/16, 25], a binary version representing a minimum value of the feature map as “1” and other values as “0” is generated, and [H/16, W/16, 25] for values that play an important role in the neural network is output.

The electronic device 100 may perform bilinear resizing 770 on the output [H/16, W/16, 25]. The bilinear resizing 770 may resize an image by using a linear interpolation method. The electronic device 100 outputs [H, W, 25] as a result of performing the bilinear resizing 770.

The electronic device 100 may perform a dot product on [H, W, 25] on which padding and stacking are performed based on [H, W, 25] output as a result of performing the bilinear resizing 770 and the luminance information 710 of the previous frame image. The padding is an operation of effectively expanding a size of a matrix by adding additional rows and columns to an image. The padding creates a buffer area around the image. The stacking refers to an operation of splitting and stacking a wide matrix having one channel. For example, rows and columns may be shifted by one space to make data of [H+4, W+4] into 25 pairs of data of [H, W]. The data obtained in this manner may be accumulated to form [H, W, 25]. The electronic device 100 may obtain the aligned luminance information [H, W, 1] 790 by performing channel-wise sum 780 on the output [H, W, 25] obtained as a result of the dot product. The channel-wise sum refers to separately summing values in each channel of a multi-channel data structure. For example, it means obtaining one [H, W, 1] value by summing elements of each row and column in the [H, W, 25] data.

In an embodiment, the electronic device 100 may obtain the aligned luminance information 790 through the image registration based on the luminance information 222 of the low-resolution image and the luminance information 710 of the previous frame image.

FIG. 8 is a diagram for describing bilinear upsampling performed for image processing, according to an embodiment of the present disclosure.

Upsampling may refer to a process of increasing a size or resolution of an image in image processing. As the size of the image is increased, pixels included in the image are added. For example, as an image of H*W is enlarged to an image of 2H*2W, a method of applying a value to an empty pixel becomes an issue. The upsampling method may include nearest upsampling, bilinear upsampling, bicubic upsampling, and the like, but is not limited thereto.

In an embodiment, when the upsampling is performed on an input value of 2X2 810, the input value may be enlarged by four times to 4X4 (820a, 820b). The nearest upsampling (820a) is a method of inserting a nearest neighboring value into an empty pixel as it is. For example, a value of 10 is intactly input into three pixels closest to 10 located at an edge, and a value of 40 is intactly input into three pixels closest to 40 located at an opposite edge. In the case of an output value 820a obtained by performing the nearest upsampling, there is a limitation in that connections between pixels are rough because only the value of the nearest pixel is considered according to the image enlargement and surrounding values are not considered.

The bilinear upsampling is an upsampling method used in an image processing process, and refers to a method using linear interpolation. In an embodiment, in the case of an output value 820b obtained by performing the bilinear upsampling on the input value of 2X2 810, the nearest value and the surrounding value may be considered together by using the linear interpolation. The linear interpolation refers to a method of, when values of end points are given, linearly calculating a value located between the end points according to a straight-line distance in order to estimate the value.

In the case of the bilinear upsampling, compared to the nearest upsampling, a relatively natural image may be completed by completing a 4x4 output value in consideration of the surrounding values together with the nearest value.

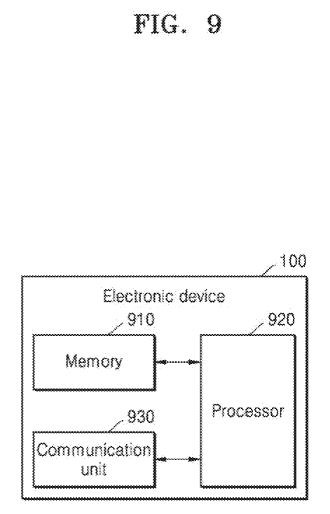

FIG. 9 is a schematic block diagram of an electronic device according to an embodiment of the present disclosure.

Referring to FIG. 9, the electronic device 100 may include a memory 910, a processor 920, and a communication unit 930. However, not all of the illustrated components are essential components of the electronic device 100. The electronic device 100 may be implemented by more components than the illustrated components, or the electronic device 100 may be implemented by fewer components.

The memory 910 may store a program for processing and control of the processor 920, and may store data input to the electronic device 100 or output from the electronic device 100. The memory 910 may include at least one type of storage medium of a flash memory type, a hard disk type, a multimedia card micro type, a card type memory (e.g., an SD memory or an XD memory), a random-access memory (RAM), a static random-access memory (SRAM), a read-only memory (ROM), an electrically erasable programmable read-only memory (EEPROM), a programmable read-only memory (PROM), a magnetic memory, a magnetic disk, and an optical disk. In an embodiment, the memory 910 may include, but is not limited to, a weight memory for storing weights and a feature vector memory for including a feature vector that is an intermediate output value of a neural network model.

In an embodiment of the present disclosure, the memory 910 may store information related to an image obtained by an operation of the processor 920. The memory 910 may store information about an obtained low-resolution image. The information about the low-resolution image may include information about an RGB image, luminance information, information about a luminance channel, information about a channel other than the luminance channel, and the like, but is not limited thereto.

In an embodiment, the memory 910 may store a plurality of weights or kernels determined through resolution enhancement learning to be applied to the neural network model. The memory 910 may store at least one feature vector obtained by using the neural network model to which the weight or the kernel is applied. The memory 910 may store an output image obtained by using the neural network model to which the weight or the kernel is applied. In an embodiment, the memory 910 may store information about at least one previous frame for the obtained low-resolution image. The information about the at least one previous frame may include information about an RGB image, luminance information, information about a luminance channel, information about a channel other than the luminance channel, and the like, but is not limited thereto.

The processor 920 controls an overall operation of the electronic device 100. For example, the processor 920 may perform functions of the electronic device 100 described in the present disclosure by executing one or more instructions stored in the memory 910. In this case, the memory 910 may store the one or more instructions executable by the processor 920. In addition, the processor 920 may store one or more instructions in an internally provided memory and may execute the one or more instructions stored in the internally provided memory to control the above-described operations to be performed. That is, the processor 920 may perform a certain operation by executing at least one instruction or program stored in the internal memory provided in the processor 920 or the memory 910.

The processor 920 may include one or more processors. In this case, the one or more processors may include a general-purpose processor such as a central processing unit (CPU), an application processor (AP), or a digital signal processor (DSP), a graphics-dedicated processor such as a graphics processing unit (GPU) or a vision processing unit (VPU), or an artificial intelligence (AI) processor such as a neural processing unit (NPU). When the one or more processors are AI processors, they may be designed as a hardware structure specialized in processing a particular AI model.

In an embodiment of the present disclosure, the processor 920 may obtain the low-resolution image through the communication unit 930. The processor 920 may convert the low-resolution image into an image including a luminance channel. The processor 920 may extract luminance information from the low-resolution image through the luminance channel. The processor 920 may command to store the extracted luminance information in the memory 910.

In an embodiment, the processor 920 may perform resolution correction on the low-resolution image through an image processing network. The processor 920 may determine a weight or a kernel to be used for the neural network model through learning for resolution enhancement by using data consisting of a pair of a low-resolution image and a high-resolution image. The processor 920 may learn a relationship between input data and output data through the learning for resolution enhancement, and may determine the weight or the kernel based on the relationship. The processor 920 may obtain at least one feature vector and an output image by using the neural network model to which the determined weight or kernel is applied. In an embodiment, the processor 920 may perform an operation by applying different weights based on neural network models having the same connection structure. The neural network models having the same connection structure may mean that hardware configurations are the same. The processor 920 may obtain a plurality of feature vectors by using a plurality of neural network models having the same connection structure. The processor 920 may obtain a high-resolution image corresponding to the low-resolution image, based on the output image obtained by using at least two neural network models.

In an embodiment, the processor 920 may perform image registration based on luminance information extracted through the luminance channel in at least one previous frame for the low-resolution image. The processor 920 may obtain aligned luminance information for resolution enhancement through the image registration. The processor 920 may obtain a feature vector by using the neural network model to which the weight is applied, by using the aligned luminance information as an input value.

In an embodiment, the processor 920 may perform image upsampling. The processor 920 may determine data to be input into an empty pixel according to the image upsampling. In an embodiment, the processor 920 may perform bilinear upsampling to obtain the high-resolution image by using the output image.

The communication unit 930 may include one or more modules that enable wireless communication between the electronic device 100 and a network in which an external device (not shown) is located. The communication unit 930 may transmit and receive data or signals to and from the external device (not shown) through a wired/wireless network. The communication unit 930 according to an embodiment of the present disclosure includes at least one communication module such as a short-range communication module, a wired communication module, a mobile communication module, a broadcast receiving module, etc. Here, the at least one communication module refers to a communication module capable of performing data transmission/reception through a network conforming to communication standards such as tuner, Bluetooth, wireless LAN (WLAN) (Wi-Fi), wireless broadband (Wibro), world interoperability for microwave access (Wimax), CDMA, WCDMA, etc.

For example, the communication unit 930 may include a Wi-Fi module, a Bluetooth module, an infrared communication module, a wireless communication module, a LAN module, an Ethernet module, a wired communication module, and the like. In this case, each communication module may be implemented in the form of at least one hardware chip. The Wi-Fi module and the Bluetooth module perform communication in a Wi-Fi method and a Bluetooth method, respectively. When the Wi-Fi module or the Bluetooth module is used, various types of connection information such as SSID and session key may be transmitted and received first, a communication connection may be performed by using the connection information, and then various types of information may be transmitted and received. The wireless communication module may include at least one communication chip that performs communication according to various wireless communication standards such as Zigbee, 3rd generation (3G), 3rd generation partnership project (3GPP), long term evolution (LTE), LTE advanced (LTE-A), 4th generation (4G), 5th generation (5G), and the like. The communication unit 930 may include a communication unit for performing communication such as Bluetooth with the electronic device, and an interface unit connected to the external device

In an embodiment of the present disclosure, the communication unit 930 may receive the low-resolution image. The communication unit 930 may receive at least one previous frame image for the low-resolution image. The communication unit 930 may transmit the high-resolution image obtained as a result of the image processing operation to a display device.

A computer-readable storage medium may be provided in the form of a non-transitory storage medium. Here, ‘non-transitory’ means that the storage medium does not include a signal (e.g., electromagnetic waves) and is tangible, but does not distinguish whether data is stored semi-permanently or temporarily in the storage medium. For example, the “non-transitory storage medium” may include a buffer in which data is temporarily stored.

According to an embodiment, a method according to various embodiments disclosed herein may be included and provided in a computer program product. The computer program product may be traded between a seller and a buyer as a product. The computer program product may be distributed in the form of a machine-readable storage medium (e.g., a compact disc read-only memory (CD-ROM)), or may be distributed (e.g., downloaded or uploaded) online through an application store or directly between two user devices (e.g., smartphones). In the case of online distribution, at least a portion of the computer program product (e.g., a downloadable app) may be at least temporarily stored in a machine-readable storage medium such as a memory of a manufacturer’s server, a server of an application store, or a relay server, or may be temporarily generated.

According to an embodiment of the present disclosure, an image processing method using a neural network model is provided. The method may obtain a low-resolution image. The method may extract luminance information from the low-resolution image through a luminance channel. The method may obtain a first feature vector based on the luminance information, by using a first neural network model to which a first weight is applied. The method may obtain an output image corresponding to the first feature vector, by using a second neural network model to which a second weight is applied. The method may generate, based on the output image, a high-resolution image for the low-resolution image. The first neural network model and the second neural network model may have the same connection structure.

In an embodiment, the method may store the first weight and the second weight obtained through learning for resolution enhancement.

In an embodiment, the method may obtain the first feature vector corresponding to the luminance information by applying the stored first weight to the first neural network model. The method may store the first feature vector. The method may obtain the output image corresponding to the first feature vector by applying the stored second weight to the second neural network model.

In an embodiment, the method may obtain a second feature vector corresponding to the luminance information by using a third neural network model to which a third weight is applied. The method may obtain the first feature vector corresponding to the second feature vector by using the neural network model to which the first weight is applied. The third neural network model may have the same connection structure as the first neural network model and the second neural network model.

In an embodiment, the number of luminance channels used for extracting the luminance information may be adjusted according to the number of input channels of the first neural network model.

In an embodiment, the number of channels of the first feature vector may be adjusted according to the number of input channels of the second neural network model.

In an embodiment, the number of channels of the first feature vector may be adjusted by duplicating a value of the first feature vector or adding a null value.

In an embodiment, the neural network model may further include at least one layer before or after the first neural network model or the second neural network model to adjust the number of channels.

In an embodiment, the method may obtain at least one previous frame image for the low-resolution image. The method may obtain aligned luminance information by performing image registration on luminance information extracted from at least one previous frame through the luminance channel and the luminance information extracted from the low-resolution image. The method may obtain the first feature vector based on the aligned luminance information and the luminance information extracted from the low-resolution image.

In an embodiment, the number of channels of the first feature vector may be variably adjusted.

In an embodiment, the method may generate the high-resolution image by performing bilinear upsampling on the output image and the low-resolution image. The high-resolution image may include an RGB image.

In an embodiment, the first neural network model and the second neural network model may include a CNN model.

According to an embodiment of the present disclosure, an electronic device for image processing using a neural network model may include a memory storing one or more instructions and at least one processor configured to execute the one or more instructions stored in the memory. The at least one processor may obtain a low-resolution image. The at least one processor may extract luminance information from the low-resolution image through a luminance channel. The at least one processor may obtain a first feature vector based on the luminance information, by using a first neural network model to which a first weight is applied. The at least one processor may obtain an output image corresponding to the first feature vector, by using a second neural network model to which a second weight is applied. The at least one processor may generate a high-resolution image for the low-resolution image, based on the output image. The first neural network model and the second neural network model may have the same connection structure.

According to an embodiment of the present disclosure, there may be provided a computer-readable recording medium having recorded thereon a program for executing the method on a computer.

1. A method for image processing using a neural network model, the method comprising:
obtaining a low-resolution image;
extracting luminance information from the low-resolution image through at least one luminance channel;
based on the luminance information, obtaining a first feature vector, by using a first neural network model to which a first weight is applied;
obtaining an output image corresponding to the first feature vector, by using a second neural network model to which a second weight is applied; and
generating a high-resolution image for the low-resolution image, based on the output image,
wherein a first connection structure of the first neural network model is the same as a second connection structure of the second neural network model.

2. The method of claim 1, further comprising:
storing, for resolution enhancement, the first weight and the second weight obtained through neural network learning,
wherein the obtaining of the first feature vector comprises applying the stored first weight to the first neural network model and storing the first feature vector, and
wherein the obtaining of the output image comprises applying the stored second weight to the second neural network model.

3. The method of claim 1, wherein the obtaining of the first feature vector comprises:
based on a third neural network model to which a third weight is applied, obtaining a second feature vector, corresponding to the luminance information; and
based on the first neural network model to which the first weight is applied, obtaining the first feature vector corresponding to the second feature vector,
wherein a connection structure of the third neural network model is the same as the connection structure of the first neural network model and the connection structure of the second neural network model.

4. The method of claim 1, wherein a number of the at least one luminance channel used for extracting the luminance information is adjusted according to a number of input channels of the first neural network model.

5. The method of claim 1, wherein a number of channels of the first feature vector is adjusted, based on a number of input channels of the second neural network model, by duplicating a value of the first feature vector or adding a null value.

6. The method of claim 1, further comprising:
obtaining at least one previous frame image from the low-resolution image;
obtaining aligned luminance information by performing image registration on luminance information, extracted from the at least one previous frame image through the at least one luminance channel, and the luminance information extracted from the low-resolution image; and
obtaining the first feature vector based on the aligned luminance information and the luminance information extracted from the low-resolution image.

7. The method of claim 1, wherein the generating of the high-resolution image comprises:
generating the high-resolution image by performing bilinear upsampling on the output image and the low-resolution image,
wherein the high-resolution image is an RGB image.

8. An electronic device for image processing using a neural network model, the electronic device comprising:
memory storing one or more instructions; and
at least one processor configured to execute the one or more instructions stored in the memory, wherein the at least one processor is configured to:
obtain a low-resolution image,
extract luminance information from the low-resolution image through at least one luminance channel,
based on the luminance information, obtain a first feature vector by using a first neural network model to which a first weight is applied,
obtain an output image corresponding to the first feature vector, by using a second neural network model to which a second weight is applied, and
generate a high-resolution image for the low-resolution image, based on the output image,
wherein a first connection structure of the first neural network model is the same as a second connection structure of the second neural network model.

9. The electronic device of claim 8, wherein the at least one processor is further configured to:
store, for resolution enhancement, the first weight and the second weight obtained through neural network learning,
obtain the first feature vector corresponding to the luminance information, by applying the stored first weight to the first neural network model,
store the first feature vector, and
obtain the output image corresponding to the first feature vector by applying the stored second weight to the second neural network model.

10. The electronic device of claim 8, wherein the at least one processor is configured to:
based on a third neural network model to which a third weight is applied, obtain a second feature vector corresponding to the luminance information, and
based on the first neural network model to which the first weight is applied, obtain the first feature vector corresponding to the second feature vector,,
wherein a connection structure of the third neural network model is the same as the connection structure of the first neural network model and the connection structure of the second neural network model.

11. The electronic device of claim 8, wherein a number of the at least one luminance channel used for extracting the luminance information is adjusted according to a number of input channels of the first neural network model.

12. The electronic device of claim 8, wherein a number of channels of the first feature vector is adjusted, based on a number of input channels of the second neural network model, by duplicating a value of the first feature vector or adding a null value.

13. The electronic device of claim 8, wherein the at least one processor is further configured to:
obtain at least one previous frame image for the low-resolution image,
obtain aligned luminance information by performing image registration on luminance information, extracted from the at least one previous frame through the at least one luminance channel, and the luminance information extracted from the low-resolution image, and
obtain the first feature vector based on the aligned luminance information and the luminance information extracted from the low-resolution image.

14. The electronic device of claim 8, wherein the at least one processor is further configured to generate the high-resolution image by performing bilinear upsampling on the output image and the low-resolution image,
wherein the high-resolution image is an RGB image.

15. A computer-readable recording medium having recorded thereon a program for executing, on a computer, the method of claim 1.
